(19) United States
(12) Patent Application Publication
(10) Pub. No.: US 2024/0392419 A1
(43) Pub. Date: Nov. 28, 2024

(54) Alloy Material With High Electrical Resistivity, Manufacturing Method Thereof and Joule Heating Tube Comprising the Same

(71) Applicant: LG Chem, Ltd., Seoul (KR)

(72) Inventors: Woochul Kim, Daejeon (KR); Mooseong Kang, Daejeon (KR)

(73) Assignee: LG Chem, Ltd., Seoul (KR)

(21) Appl. No.: 18/690,881

(22) PCT Filed: Jun. 27, 2023
(86) PCT No.: PCT/KR2023/008922

§ 371 Date: Mar. 11, 2024

(30) Foreign Application Priority Data
Jul. 5, 2022 (KR) 10-2022-0082518
Jun. 20, 2023 (KR) 10-2023-0079278

(51) Int. Cl. C22C 30/00; C22C 19/05; F24H 1/10; H05B 3/12

(52) U.S. Cl. CPC C22C 30/00; C22C 19/058; F24H 1/105; H05B 3/12

(57) ABSTRACT

An alloy material includes an alloy containing at least Ni, Al and Ti. The alloy material includes a face centered cubic structure (FCC) matrix and a precipitate formed in the matrix-. The alloy material exhibits predetermined peak characteristics; and has a high resistivity.

### CROSS-REFERENCE TO RELATED APPLICATION

This application claims the benefits of Korean Patent Applications No. 10-2022-0082518 filed on Jul. 5, 2022 and No. 10-2023-0079278 filed on Jun. 20, 2023 with the Korean Intellectual Property Office, the disclosure of which is incorporated herein by reference in its entirety.

### TECHNICAL FIELD

The present disclosure relates to an alloy material, a manufacturing method thereof, and a joule heating tube including the same. Specifically, the present disclosure relates to an alloy material having high electrical resistivity and excellent mechanical properties at high temperatures compared to conventional alloys, a manufacturing method thereof, and a joule heating tube including the same.

### BACKGROUND OF ART

In order to realize carbon neutrality in the petrochemical field, it is necessary to switch the heat source of a hydrocarbon pyrolysis furnace from an indirect heating method using fossil fuels to a joule heating method.

The metal material applied to the existing cracking tube has low resistivity, so when applying a joule heating method, it may cause an overload of circuit wires and require additional energy for cooling. In addition, it is necessary to apply a current with high density to heat the tube to the hydrocarbon pyrolysis temperature by applying a joule heating method and to maintain it. When a high current is applied, a phenomenon in which diffusion of atoms is accelerated may occur in a metal material due to an athermal effect. Since deformation of the metal material at high temperatures is caused by dislocation movement due to diffusion of atoms or shear deformation, conventional hydrocarbon cracking tube materials may show problems in that creep deformation rate increases and strength decreases when a joule heating method is applied.

### DETAILED DESCRIPTION OF THE INVENTION

### Technical Problem

The present disclosure relates to an alloy material having high electrical resistivity compared to conventional alloy materials.

The present disclosure also relates to an alloy material having improved mechanical properties at high temperatures compared to conventional alloy materials.

The present disclosure also relates to an alloy material having excellent room temperature processability.

The present disclosure also relates to an alloy material suitable for an electric or joule heating type hydrocarbon cracking furnace.

The above and other objects of the present disclosure can all be solved by the present disclosure described in detail below.

### Technical Solution

According to the present disclosure, there are provided an alloy material to be described later and a joule heating tube including the same.

### Alloy Material

In one embodiment of the present disclosure, the present disclosure relates to an alloy (or alloy material).

The alloy of the present disclosure may have a high resistivity to prevent an overload of wires when a current is applied, and may have a microstructure and a distorted lattice structure capable of suppressing a metal element diffusion phenomenon caused by an athermal effect during joule heating. At this time, the microstructure includes a matrix (face centered cubic structure) to be described later. In addition, according to an embodiment of the present disclosure, the microstructure may further include a precipitate that may have a lattice structure (e.g., a regular lattice structure). Also, the distorted lattice structure deviates from the ideal lattice structure, and refers to a structure exhibited by severe lattice distortion.

In this regard, FIG. 1 shows a lattice of a face centered cubic (FCC) phase composed of single atoms and a lattice of a face centered cubic (FCC) phase having a distorted lattice structure composed of 5 or more elements. Specifically, as shown in FIG. 1(a), the lattice composed of single atoms has an ideal lattice structure in which the distance between atoms is constant, whereas the lattice composed of multiple atoms (e.g., 5 or more elements) in FIG. 1(b) may have a distorted lattice structure due to the difference in bonding force between atoms. The distorted lattice structure can provide characteristics suitable for high-temperature joule heating materials for reasons described below.

First of all, the distorted lattice structure can improve strength and increase creep lifespan by suppressing the glide or climb of dislocations that cause deformation of the metal material at high temperatures. In addition, a material having a distorted lattice structure has a shorter mean free path due to increased scattering of electrons when current is applied, thereby providing high resistivity. Accordingly, when a material having a distorted lattice structure is connected in a series circuit, the relative amount of Joule heating compared to that of the conducting wire can be increased, and thus it can be used as a heating material. In addition, a material having a distorted lattice structure may retard the athermal effect of the material generated during joule heating. At this time, the athermal effect of the material means a decrease in bonding force between atoms caused by the current along with the temperature rise during joule heating, which can accelerate the high-temperature deterioration of the material related to the diffusion phenomenon. On the other hand, a material having a distorted lattice structure has a high activation energy required for diffusion due to a sluggish diffusion effect, and thus has an aspect suitable for suppressing a deterioration phenomenon related to diffusion.

Considering the above points, the alloy designed according to the embodiment of the present disclosure is composed of 5 or more types of elements and may have a distorted lattice structure.

In one example, the alloy material may include a predetermined content of Ni as an essential element. Ni is not only a main component of the matrix, but also serves to form a precipitate with a regular structure that is stable at high temperatures.

In one example, the alloy material may include Al and Ti as essential elements in addition to Ni. The Al and Ti serve to form a precipitate together with Ni and increase the production fraction of the precipitate. However, if Al and Ti are excessively added, a brittle BCC structure or sigma phase may be formed (excess enough to cause deterioration of physical properties), so it is necessary to appropriately limit the upper limit of the content (e.g., each of Al content and Ti content in all metal elements constituting the alloy is 15 atomic % or less).

In one example, the alloy material may have a FeₐNi_{b}Co_{c}Cr_{d}AlₑTi_{f}X_{g} composition. In addition, the alloy material of this composition may have a face centered cubic structure (FCC). Herein, a+b+c+d+e+f=100 (at %), 0≤a≤20 (at %), 35≤b≤65 (at %), 0≤c≤35 (at %), 0≤d≤20 (at %), 2≤e≤15 (at %), 2≤f≤15 (at %), and at % is atomic %. Further, X is an element satisfying g≤3 (at %), and may include one or more selected from the group consisting of Mo, Mn, Si, W, Zr, Nb, Hf, and B. Although not particularly limited, the lower limit of at % (atomic %) of the trace element X is greater than 0, and may be, for example, 0.0001 at % or 0.001 at %.

The content of each element can be appropriately adjusted within a range considering resistivity characteristics.

In one example, a related to the Fe content in FeₐNi_{b}Co_{c}Cr_{d}AlₑTi_{f}X_{g} may be 4 (at %) or more, 6 (at %) or more, 8 (at %) or more, 10 (at %) or more, 12 (at %) or more, 14 (at %) or more, 16 (at %) or more, or 18 (at %) or more, and 18 (at %) or less, 16 (at %) or less, 14 (at %) or less, 12 (at %) or less, 10 (at %) or less, 8 (at %) or less, or 6 (at %) or less.

In one example, b related to the Ni content in FeₐNi_{b}Co_{c}Cr_{d}AlₑTi_{f}X_{g} may be 36 (at %) or more, 38 (at %) or more, 40 (at %) or more, 42 (at %) or more, 44 (at %) or more, 46 (at %) or more, 48 (at %) or more, 50 (at %) or more, 52 (at %) or more, 54 (at %) or more, 56 (at %) or more, 58 (at %) or more, or 60 (at %) or more, and 58 (at %) or less, 56 (at %) or less, 54 (at %) or less, 52 (at %) or less, 50 (at %) or less, 48 (at %) or less, 46 (at %) or less, 44 (at %) or less, 42 (at %) or less, 40 (at %) or less, or 38 (at %) or less.

In one example, c related to the Co content in FeₐNi_{b}Co_{c}Cr_{d}AlₑTi_{f}X_{g} may be 10 (at %) or more, 12 (at %) or more, 14 (at %) or more, 16 (at %) or more, 18 (at %) or more, or 20 (at %) or more, and 30 (at %) or less, 28 (at %) or less, 26 (at %) or less, 24 (at %) or less, 22 (at %) or less, 20 (at %) or less, or 18 (at %) or less.

In one example, d related to the Cr content in FeₐNi_{b}Co_{c}Cr_{d}AlₑTi_{f}X_{g} may be 2 (at %) or more, 4 (at %) or more, 6 (at %) or more, 8 (at %) or more, 10 (at %) or more, 12 (at %) or more, 14 (at %) or more, 16 (at %) or more, or 18 (at %) or more, and 18 (at %) or less, 16 (at %) or less, 14 (at %) or less, 12 (at %) or less, 10 (at %) or less, or 8 (at %) or less.

In one example, e related to the Al content in FeₐNi_{b}Co_{c}Cr_{d}AlₑTi_{f}X_{g} may be 4 (at %) or more, 6 (at %) or more, 8 (at %) or more, 10 (at %) or more, 12 (at %) or more, or 14 (at %) or more, and 14 (at %) or less, 12 (at %) or less, or 10 (at %) or less.

In one example, f related to the Ti content in FeₐNi_{b}Co_{c}Cr_{d}AlₑTi_{f}X_{g} may be 4 (at %) or more, 6 (at %) or more, 8 (at %) or more, 10 (at %) or more, 12 (at %) or more, or 14 (at %) or more, and 14 (at %) or less, 12 (at %) or less, 10 (at %) or less, 8 (at %) or less, 6 (at %) or less, or 4 (at %) or less.

In one example, g related to the X content in FeₐNi_{b}Co_{c}Cr_{d}AlₑTi_{f}X_{g} may be 2.5 (at %) or less, 2.0 (at %) or less, 1.5 (at %) or less, 1.0 (at %) or less, 0.5 (at %) or less, or 0.1 (at %) or less. More specifically, it may be 0.01 (at %) or less. In addition, the lower limit may be, for example, 0.0001 at % or 0.001 at %.

In one example, the alloy material may include a precipitate. Specifically, the alloy material may include a precipitate formed (e.g., dispersed) in a face-centered cubic structure (in a matrix). At this time, the precipitate may have one or more lattice structures (e.g., a regular lattice structure) selected from L1₂, L2₁, B2, and D022, and serve to reinforce the above-described FCC matrix (function as a reinforcing phase). In addition, the precipitate of the regular structure may have a coherent interface or a semi-coherent interface with a face centered cubic structure (FCC), which is a matrix.

For example, through the thermodynamic phase diagrams of FIGS. 2A and 2B, it is confirmed that the alloy according to the present disclosure may have an FCC matrix and a precipitated phase (reinforcing phase) having an L1₂ structure.

In one example, in X-ray diffraction measurement using CuKα rays, the alloy has peaks of a matrix (FCC) and a precipitate (e.g., L12 precipitate) around 2θ=44±1°, 51±1°, and 74±1°, and may have a superlattice peak of a precipitate (e.g., L12 precipitate) around 2θ=24±1° (see FIG. 3a).

In the specific embodiment of the present disclosure, the lattice constant (It is a length of one side of a cube, which is a unit cell, and can be confirmed by a known method.) a, z of each phase can be derived from the peaks of the matrix (FCC) and the precipitate (e.g., L1₂) shown in the X-ray diffraction analysis. The alloy may have a coherent interface or a semi-coherent interface, because the alloy has the lattice mismatch (δ_{XRD}=2×(a_{FCC}−a_{L1}_{₂})/(a_{FCC}+a_{L1}_{₂})) calculated from the derived lattice constant within the range of −1.0% or more and +1.0% or less.

Regarding the diffraction analysis of the alloy, the phases constituting each alloy is confirmed in FIG. 3 of the X-ray diffraction analysis results for the alloys of Examples 1 to 8. Specifically, in the alloys according to specific embodiments of the present disclosure shown in FIG. 3a (e.g., Examples 2 to 4 and 6 to 8), the secondary phase of a BCC structure is present in addition to the FCC matrix and the L1₂ precipitate. As the Fe content in the alloy increases, the fraction tends to increase.

Regarding the diffraction analysis of the alloy, the lattice constant of each phase is derived through peak separation in FIG. 3b, which enlarges the range of 2θ=43-44.5° in which the FCC (111) and L1₂ (111) peaks of the alloy of Example 1 appear, and cofirmed to be a_{FCC}=3.574 Å, a_{L1}_{₂}=3.583 Å, δ_{XRD}=0.26%. Considering that the lattice mismatch is sufficiently small, it can be seen that a coherent interface or a semi-coherent interface is formed at the interface of the two phases, and thus the function of matrix reinforcement can be performed.

As described above, the precipitate formed in the matrix has a regular structure such as L1₂, L2₁, B2 and/or D022 and forms a coherent interface or a semi-coherent interface with the FCC matrix. This precipitate not only increases the resistivity compared to the alloy composed of single-phase FCC due to electron scattering at the interface between the precipitate and the matrix, but also improves the high-temperature strength of the alloy by strengthening the matrix due to the precipitation strengthening mechanism.

In one example, the alloy material may include the precipitate having a regular lattice structure at 70 volume % or less of the total volume of the alloy material.

Specifically, the upper limit of the volume % of the precipitate in the alloy material may be 65 volume % or less, 60 volume % or less, 55 volume % or less, 50 volume % or less, or 45 volume % or less. In addition, the lower limit may be, for example, 5 volume % or more, 10 volume % or more, 20 volume % or more, 30 volume % or more, 40 volume % or more, 50 volume % or more, or 60 volume % or more. Also, the fraction of the precipitate may preferably be at least 40% or more of the total volume of the alloy.

FIG. 4 is a result of analyzing the microstructure by SEM (Scanning Electron Microscopy) for the alloy of Example 1 and the alloy of Example 5 composed of FCC and L1₂ phases in X-ray diffraction analysis. As a result of measuring the phase fraction through the Image J program, the volume fraction of the L1₂ precipitate was 68.4 volume % in the alloy of Example 1 and 73.2 volume % in the alloy of Example 5.

The alloy not only causes electron scattering at the interface of the precipitate distributed in the FCC matrix in a microstructure, but also increases the degree of electron scattering when current is applied due to a severe lattice distortion effect in the lattice structure, thereby exhibiting high resistivity. In addition, in the case of conventional metal materials, the diffusion phenomenon may be accelerated due to the athermal effect of the material during joule heating, but the alloy of the present disclosure can suppress this from the sluggish diffusion effect. Therefore, the alloy material of the present disclosure may have further improved joule heating efficiency and durability than can be expected from conventional heat-resistant alloys.

In one example, the alloy may be a medium-entropy or high-entropy alloy. According to a configurational entropy, the medium-entropy may mean that the configurational entropy ranges from 1.00 R (R: gas constant) to 1.50 R, and the high-entropy may mean the configurational entropy is 1.50 R or more. Specifically, the alloy material of the present disclosure may have the configurational entropy of 1.25R or more, 1.30R or more, 1.35R or more, 1.40R or more, 1.45R or more, or 1.50R or more.

In this regard, referring to Table 1, it is confirmed that the alloys of Examples 1 to 8 have the configurational entropy (|ΔSₘᵢₓ|) of 1.40R (R is gas constant) or more. This is higher than the configurational entropy (1.02R to 1.20R) of the commercialized heat-resistant alloys of Comparative Examples 1 to 3.

In one example, the alloy material may have a resistivity of 140 μΩcm or more. Conventionally known high-resistivity materials include NiCr-based alloys and FeNiCr-based commercial alloys. The former has a room temperature resistivity of 112 μΩcm, which is lower than that of the alloy proposed in the present disclosure, and the latter is an alloy with a BCC structure and has low cold workability, so there are limitations in the shape of use.

Specifically, the resistivity of the alloy material may be, for example, 150 μΩcm or more, 160 μΩcm or more, 170 μΩcm or more, 180 μΩcm or more, 190 μΩcm or more, or 200 μΩcm or more. Although not particularly limited, the upper limit of the resistivity of the alloy material is, for example, 250 μΩcm or less, 240 μΩcm or less, 230 μΩcm or less, 220 μΩcm or less, 210 μΩcm or less, 200 μΩcm or less, 190 μΩcm or less, 180 μΩcm or less, 170 μΩcm or less or less, 160 μΩcm or less, or 150 μΩcm or less.

The resistivity may be measured using the 4 Point Probe method or the Van der Pauw method. According to the specific embodiments of the present disclosure, it can be measured by the Van der Pauw method described in Examples and FIG. 5 to be described later. Although not particularly limited, the resistivity may be measured from a hexahedron test piece having a width of 5 to 15 mm, a length of 5 to 15 mm, and a height of 0.5 to 1.5 mm (e.g., resistivity measured with a cuboid test piece having a width of 8 mm, a length of 8 mm, and a height of 1 mm).

### Manufacturing Method of Alloy Material

In another embodiment of the present disclosure, the present disclosure relates to a manufacturing method of the alloy material having the above-described composition. For example, the alloy material of the present disclosure may be manufactured by plasma arc melting and heat-treatment (e.g., homogenization and/or aging heat-treatment) as described below. In performing this method, the precipitate may be formed in different fractions and sizes in the matrix according to the temperature and time of the aging heat-treatment, and this precipitate may improve the strength of the alloy at high temperatures and further increase the resistivity.

Specifically, the method includes the steps of melting an ingot for producing an alloy by a plasma arc melting method; and performing homogenization heat-treatment at a temperature of 1100 to 1400° C. for 1 to 24 hours.

More specifically, in the above method, the alloying elements are weighed, and then an ingot is prepared by plasma arc melting. The plasma arc melting method can minimize the formation of inclusions compared to induction melting, and is effective in minimizing the formation of cavities by solidification shrinkage.

Next, the ingot is subjected to a homogenization treatment at high temperatures, through which macroscopic and microscopic segregation generated during the casting process is removed. The conditions for homogenization treatment may vary depending on the size of the ingot. For example, in the present disclosure, the homogenization treatment may be performed for 1 to 24 hours in an electric heating furnace set in the range of 1100 to 1400° C. in consideration of the stabilization temperature range of the single-phase FCC.

The precipitate may be formed in the process of cooling the homogenized ingot, and aging treatment is additionally performed to stabilize the composition and distribution of the precipitate. Specifically, according to one embodiment of the present disclosure, the method may further include a step of stably dispersing the precipitate (e.g., precipitate of regular lattice) in a face centered cubic structure (FCC) by aging heat-treatment of the alloy subjected to homogenization heat-treatment at a temperature of 700 to 1000° C. for 1 to 100 hours.

The conditions for the aging heat-treatment may vary depending on the composition, and may be performed at a temperature of 1000° C. for 1 to 100 hours in consideration of the formation temperature and fraction of the phase precipitate.

Joule heating tube In another embodiment of the present disclosure, the present disclosure relates to a joule heating tube. The joule heating tube is used in a so-called hydrocarbon pyrolysis (cracking) furnace for hydrocarbon cracking, and includes an alloy material having the above-described composition.

The above-described alloy material not only causes electron scattering at the interface of the precipitate distributed in the FCC matrix in a microstructure, but also increases the degree of electron scattering when current is applied due to a severe lattice distortion effect in the lattice structure, thereby exhibiting high resistivity. In addition, in the case of conventional metal materials, the diffusion phenomenon may be accelerated due to the athermal effect of the material during joule heating, but the alloy of the present disclosure can suppress this from the sluggish diffusion effect. Therefore, the alloy material of the present disclosure may have further improved joule heating efficiency and durability than can be expected from conventional heat-resistant alloys.

### Advantageous Effects

According to specific embodiments of the present disclosure, there is provided an alloy material having high electrical resistivity compared to conventional alloys, reduced deterioration of mechanical properties (e.g., high-temperature strength or high-temperature tensile properties) during joule heating, and excellent room temperature processability. The alloy material of the present disclosure can be used in an electric heating-based hydrocarbon pyrolysis tube used in a high-current, high-temperature environment. Accordingly, the present disclosure has the effect of providing a joule heating tube including the alloy material.

### BRIEF DESCRIPTION OF THE DRAWINGS

FIG. 1 shows a lattice structure. Specifically, FIG. 1a shows a lattice having an ideal face centered cubic (FCC) structure, and FIG. 1b shows a lattice of a high-entropy alloy having a distorted FCC lattice structure due to differences in size and bonding force between atoms.

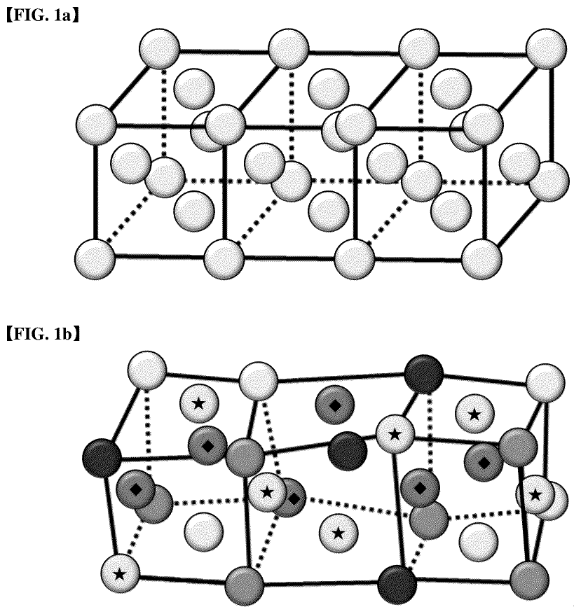

FIG. 2 relates to a phase diagram. Specifically, FIGS. 2a and 2b are phase diagrams derived using Thermo-calc software for eight high-entropy alloys designed in Examples, showing the volume fraction of the constituent phases according to temperature. In the alloys of Examples, the L1₂ precipitate fraction increases as the Ti content increases, and decreases as the Fe content increases. In addition, the higher the Ti or Fe content, the higher the BCC phase fraction.

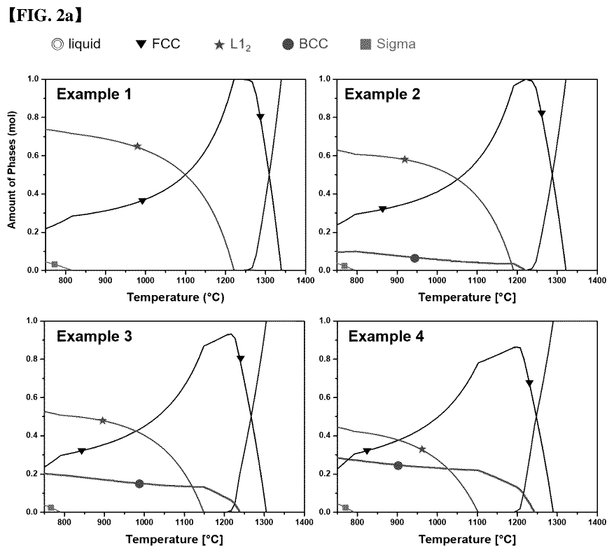

FIG. 3 is an X-ray diffraction (XRD) analysis result. Specifically, FIG. 3a is an X-ray diffraction analysis result for eight high-entropy alloys designed in Examples (Examples 1 to 8 in order from bottom to top). FIG. 3b is an enlarged observation of the X-ray diffraction analysis result for the alloy of Example 1 in the range of 2θ=42˜44.5°, and is a result of separating the peaks of the two phases FCC and L1₂.

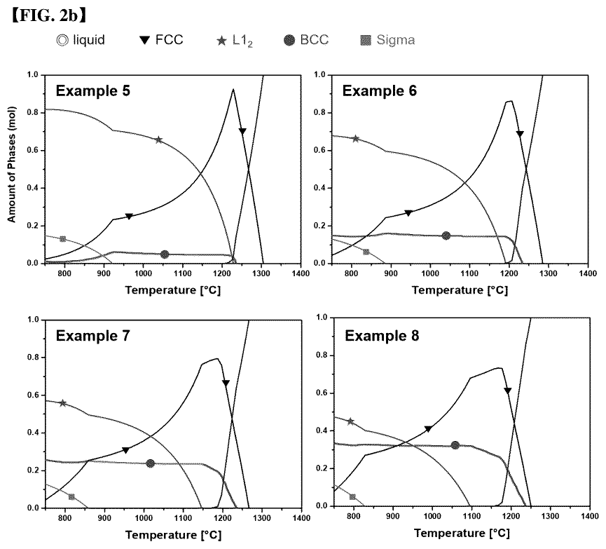

FIG. 4 shows photographs of the microstructure. Specifically, it shows microstructure images obtained by SEM (Scanning Electron Microscopy) for (a) Ni₅₂Fe₄Ti₆Al₁₂Cr₁₀Co₁₆B_{0.005} alloy of Example 1 and (b) Ni₅₀Fe₄Ti₈Al₁₂Cr₁₀Co₁₆B_{0.005} alloy of Example 5.

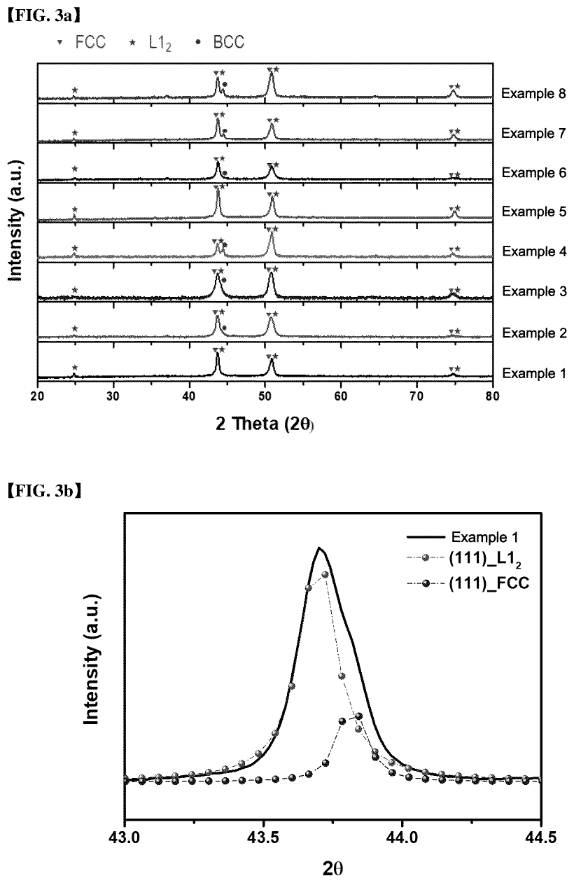

FIG. 5 shows a Van der Pauw measurement method introduced to measure a resistivity of an alloy prepared in Example of the present disclosure, and the resistivity is measured while changing the position of the current and voltage probes under the application of a constant current. Specifically, after applying the constant current I₁₂ to both ends of contacts 1 and 2, the voltage V₄₃ appearing between contacts 3 and 4 was measured to calculate resistance R1 with the ratio of current and voltage. Then, applying the constant current I₂₃ to both ends of contacts 2 and 3, the voltage V₁₄ appearing between contacts 1 and 4 was measured to calculate resistance R2 with the ratio of current and voltage. In addition, a resistivity can be derived from the resistances R1 and R2 and the thickness of the measurement sample. Compared to the 4-Point-Probe method, this method allows the confirmation of anisotropic effects in crystalline materials and provides relatively high reliability.

FIG. 6 is a result of a resistivity evaluation of the alloy of Examples.

### DETAILED DESCRIPTION OF THE EMBODIMENTS

Hereinafter, the action and effect of the invention will be described in more detail with specific examples of the present invention. However, these are presented as an example of the invention, and thereby the scope of the present invention is not limited thereto.

### Manufacture of Alloys and Evaluation of Resistivity

Eight alloys of Examples were prepared with the following composition (atomic %). Comparative Examples 1, 2 and 3 are commercially available products, Inconel® 601 (Comparative Example 1), Incoloy® 800HT (Comparative Example 2) and Kanthal® APMT (Comparative Example 3), respectively.

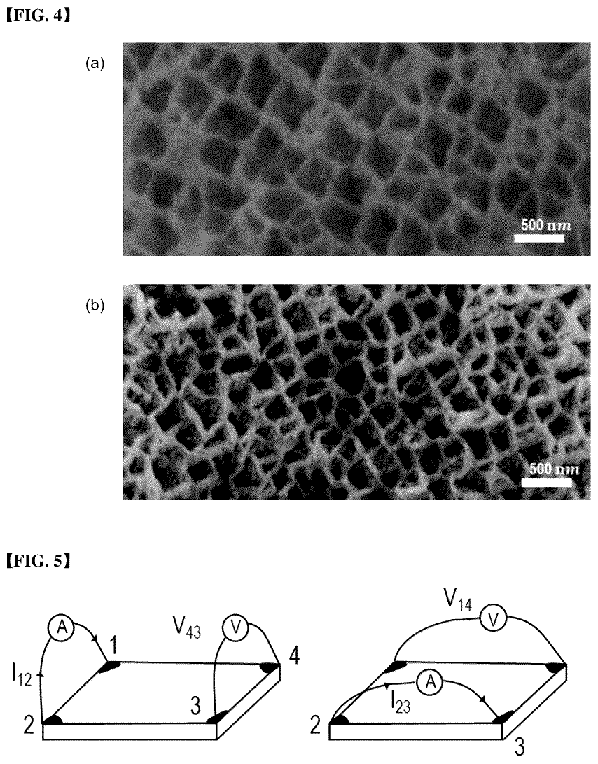

The resistivity was measured according to the Van der Pauw measurement method for the alloys of Examples with the above composition (see FIG. 5). This method can confirm the anisotropic effect of crystalline materials, and the reliability of the result is higher than that of the 4-Point-Probe measurement method. Specifically, the resistivity was measured (applied current 100 mA, 10 measurements per sample) while changing the positions of the current and voltage probes under constant current application, and the positions of the current/voltage probes were changed 8 times for one measurement.

The measured resistivity of the alloys of Examples was compared with commercial products (Inconel® 601, Incoloy® 800HT and Kanthal® APMT).

TABLE 1

| | Ni | Fe | Ti | Al | Cr | Co | B | Nb | Si | Mn | C | Mo |
|---|---|---|---|---|---|---|---|---|---|---|---|---|
| Ex. 1 | 52 | 4 | 6 | 12 | 10 | 16 | 0.005 | — | — | — | — | — |
| Ex. 2 | 48 | 8 | 6 | 12 | 10 | 16 | 0.005 | — | — | — | — | — |
| Ex. 3 | 44 | 12 | 6 | 12 | 10 | 16 | 0.005 | — | — | — | — | — |
| Ex. 4 | 40 | 16 | 6 | 12 | 10 | 16 | 0.005 | — | — | — | — | — |
| Ex. 5 | 50 | 4 | 8 | 12 | 10 | 16 | 0.005 | — | — | — | — | — |
| Ex. 6 | 46 | 8 | 8 | 12 | 10 | 16 | 0.005 | — | — | — | — | — |
| Ex. 7 | 42 | 12 | 8 | 12 | 10 | 16 | 0.005 | — | — | — | — | — |
| Ex. 8 | 38 | 16 | 8 | 12 | 10 | 16 | 0.005 | — | — | — | — | — |
| Comp. | 20.5 | 47.5 | — | — | 28 | — | — | — | — | 1.5 | 2.0 | 0.5 |
| Ex. 1 | | | | | | | | | | | | |
| Comp. | 59.3 | 7.7 | — | 3.5 | 26.5 | 1.0 | — | — | 1.0 | 1.0 | — | — |
| Ex. 2 | | | | | | | | | | | | |
| Comp. | — | 63 | — | 9.7 | 23.6 | 0 | — | — | 1.3 | 0.4 | 0.4 | 1.6 |
| Ex. 3 | | | | | | | | | | | | |

TABLE 2

| | \| ΔSₘᵢₓ \| | Resistivity (μΩcm) | Microstructure |
|---|---|---|---|
| Ex. 1 | 1.42R | 144.2 | FCC + L1₂ |
| Ex. 2 | 1.50R | 142.3 | FCC + L1₂ + BCC |
| Ex. 3 | 1.56R | 141.6 | FCC + L1₂ + BCC |
| Ex. 4 | 1.61R | 138.8 | FCC + L1₂ + BCC |
| Ex. 5 | 1.46R | 150.7 | FCC + L1₂ |
| Ex. 6 | 1.54R | 148.0 | FCC + L1₂ + BCC |
| Ex. 7 | 1.60R | 149.3 | FCC + L1₂ + BCC |
| Ex. 8 | 1.64R | 143.4 | FCC + L1₂ + BCC |
| Comp. Ex. 1 | 1.20R | 85 | FCC + Ti, Cr |
| | | | Carbide + Ti Nitride |
| Comp. Ex. 2 | 1.11R | 119 | FCC + Cr |
| | | | Carbide + Ti Nitride |
| Comp. Ex. 3 | 1.02R | 138.5 | FCC + Al-rich |
| | | | particle + Si-rich |
| | | | particle |

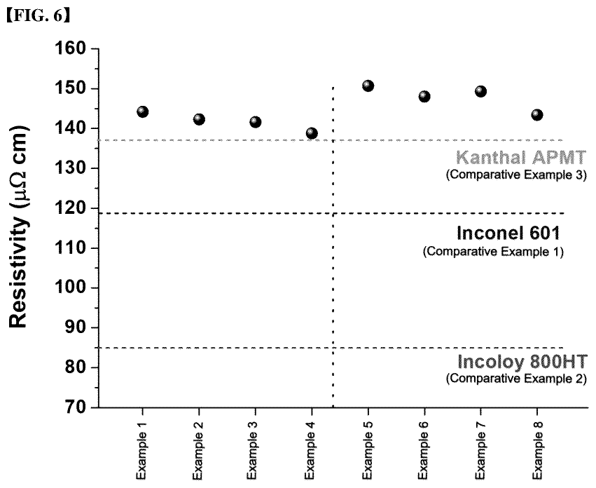

Referring to the above tables and FIG. 6, Inconelo 601 of Comparative Example 1 and Incoloy® 800HT of Comparative Example 2, which are commercially available cracking tube materials, have a room temperature resistivity as low as 85 μΩcm and 119 μΩcm, respectively. In addition, Kanthalo APMT alloy of Comparative Example 3, which is a high resistivity material, has a room temperature resistivity of 138.5 μΩcm, which is similar to that of the alloy of Examples, but has low cold workability, so there are limitations in the shape of use.

On the other hand, the alloy materials represented by Examples 1 to 8 have an FCC matrix with excellent processability, so that a centrifugal casting process, which is a typical cracking tube manufacturing process, can be applied. In addition, there is an advantage in that it can be manufactured into a tube shape by a plastic working process such as rolling and drawing, and can be processed into a complex shape such as a coil by subsequent processing. In particular, the alloy material of the present disclosure has a higher temperature coefficient (due to lattice distortion reflected from high configurational entropy), which indicates a change in resistivity with increasing temperature, than that of common commercial alloys, so that a heating efficiency with increasing temperature can be better.

Although the present invention has been shown and described with limited examples and drawings, it will be apparent to those skilled in the art that modifications and variations can be made without departing from the spirit and scope of the invention as defined by the appended claims.

1. An alloy material comprising an alloy containing at least Ni, Al and Ti,
wherein the alloy material comprises a matrix of a face centered cubic structure (FCC) and a precipitate of a lattice structure formed in the matrix, and
wherein the alloy has peaks of the matrix and the precipitate at about 2θ=44±1°, 51±1°, and 74±1°, and a superlattice peak of the precipitate at about 2θ=24±1° in X-ray diffraction measurement using CuKα rays.

2. The alloy material of claim 1,
wherein the alloy material satisfies a resistivity of 140 μΩcm or more.

3. The alloy material of claim 1,
wherein the precipitate has one or more lattice structures f L1₂, L2₁, B2, or D022.

4. The alloy material of claim 3,
wherein the precipitate has a coherent interface or a semi-coherent interface with the face centered cubic structure (FCC).

5. The alloy material of claim 3,
wherein the precipitate is included in an amount of 70 volume % or less of a total volume of the alloy material.

6. The alloy material of claim 1,
wherein the alloy material has a configurational entropy of 1.4 R or more, wherein R is a gas constant.

7. The alloy material of claim 1,
wherein an amount of each of Al and Ti is 15 atomic % or less relative to all metal elements constituting the alloy.

8. The alloy material of claim 1,
wherein the alloy has a FeₐNi_{b}Co_{c}Cr_{d}AlₑTi_{f}X_{g} composition,
wherein a+b+c+d+e+f=100 atomic %,
0≤a≤20 atomic %, 35≤b≤65 atomic %, 0≤c≤35 atomic %, 0≤d≤20 atomic %, 2≤e≤15 atomic %, and 2≤f≤15 atomic %, and
wherein X is an element satisfying g≤3 atomic % and contains one or more selected from the group consisting of Mo, Mn, Si, W, Zr, Nb, Hf, and B.

9. The alloy material of claim 8,
wherein in the FeₐNi_{b}Co_{c}Cr_{d}AlₑTi_{f}X_{g} composition of the alloy, 0≤g≤3 atomic %.

10. A joule heating tube for a hydrocarbon cracking reactor comprising the alloy material according to claim 1.

11. An alloy material having a FeₐNi_{b}Co_{c}Cr_{d}AlₑTi_{f}X_{g} composition,
wherein a+b+c+d+e+f=100 atomic %,
0≤a≤20 atomic %, 35≤b≤65 atomic %, 0≤c≤35 atomic %, 0≤d≤20 atomic %, 2≤e≤15 atomic %, and 2≤f≤15 atomic %, and
wherein, X is an element satisfying g≤3 atomic % and contains one or more selected from the group consisting of Mo, Mn, Si, W, Zr, Nb, Hf, and B.

12. The alloy material of claim 11,
wherein an amount of each of Al and Ti is 15 atomic % or less relative to all metal elements constituting the alloy.

13. The alloy material of claim 11,
wherein, in the FeₐNi_{b}CoₑCr_{d}AlₑTi_{f}X_{g} composition of the alloy, 0<g≤3 atomic %.

14. The alloy material of claim 11,
wherein the alloy material satisfies a resistivity of 140 μΩcm or more.

15. A joule heating tube for a hydrocarbon cracking reactor comprising the alloy material according to claim 11.

16. The alloy material of claim 2, wherein the alloy material satisfies the resistivity of from 140 μΩcm 250 μΩcm.

17. The alloy material of claim 5, wherein the precipitate is included in an amount of from 5 volume % to 70 volume % relative to the total volume of the alloy material.

18. The alloy material of claim 14, wherein the alloy material satisfies the resistivity of from 140 μΩcm 250 μΩcm.
